(19) United States
(12) Patent Application Publication
(10) Pub. No.: US 2016/0063648 A1
(43) Pub. Date: Mar. 3, 2016

(54) METHODS AND SYSTEMS FOR RECOMMENDING VOLUNTEER OPPORTUNITIES TO PROFESSIONALS

(71) Applicant: Linkedin Corporation, Mountain View, CA (US)

(72) Inventors: Monica Lewis, Mountain View, CA (US); Elaine Pang, Mountain View, CA (US); Vibhu Prakash Saxena, San Jose, CA (US); Jake Bailey, Mountain View, CA (US)

(21) Appl. No.: 14/473,279

(22) Filed: Aug. 29, 2014

(51) Int. Cl. G06Q 50/00; G06Q 10/10; G06Q 30/02

(52) U.S. Cl. CPC G06Q 50/01; G06Q 30/0279; G06Q 10/1053

(57) ABSTRACT

Systems and methods are presented for recommending volunteer opportunities to users in an online network. In some embodiments, a method is presented. The method may include accessing, in a device, at least one member profile attribute of a user in an online network, the at least one member profile attribute associated with a plurality of volunteer opportunities. The method may also include accessing information associated with the plurality of volunteer opportunities, generating a relevance score for each of the plurality of volunteer opportunities based on the at least one member profile attribute and the information associated with the plurality of volunteer opportunities, ranking the plurality of volunteer opportunities based on the relevance scores, and displaying at least some of the plurality of volunteer opportunities to the user based on the ranking.

### TECHNICAL FIELD

The subject matter disclosed herein generally relates to social networking. In some example embodiments, the present disclosure relates to systems and methods for recommending volunteer opportunities to professionals.

### BRIEF DESCRIPTION OF THE DRAWINGS

Some embodiments are illustrated by way of example and not limitation in the figures of the accompanying drawings.

FIG. 1 is a network diagram illustrating a network environment, according to some example embodiments.

FIG. 2 a block diagram illustrating various modules of an online social network, according to some example embodiments.

FIG. 3 is an example member profile of a user of the online social network, which can be used to assist in recommending volunteer opportunities to the user, according to aspects of the present disclosure.

FIG. 4 is an example modification of some attributes of the member profile, according to some example embodiments.

FIG. 5 is an example communication for recommending volunteer opportunities to the user, according to some example embodiments.

FIG. 6 is a flowchart illustrating example operations for recommending volunteer opportunities to users in the online social network, according to some example embodiments.

FIG. 7 is a block diagram illustrating components of a machine, according to some example embodiments, able to read instructions from a machine-readable medium and perform any one or more of the methodologies discussed herein.

### DETAILED DESCRIPTION

Example methods, apparatuses, and systems are presented for recommending volunteer opportunities to professionals through an online social network. The advent of social networks and other social media have allowed many users to easily access videos, articles, and other information oftentimes for entertainment purposes. In general, online services have enabled entertainment media to be ever more accessible to online users. Meanwhile, efforts to promote charity and other volunteer services have improved, but have not become as accessible to online users as quickly or as prolifically as simple entertainment media. While online users can search the Internet for volunteer opportunities, oftentimes many additional steps may be needed to connect a potential volunteer with a volunteer organization that fits their interests and is geographically plausible. Unlike various websites and social networks that have been designed to provide convenient access to entertainment and other potentially distracting activities, few online means are available, if any, to provide that same or comparable access to community involvement or other volunteer work. As a result, the amount of volunteering may be reduced or hampered. In general, there is a need to provide volunteer opportunities to online users through means that are more accessible and fitting to users' specific interests.

Aspects of the present disclosure are presented for recommending volunteer opportunities to users in an online context. In some example embodiments, the online users may be working professionals who have various experiences and skills that can cater to particular volunteer opportunities and services. In some example embodiments, an online service, such as a social network that caters to professionals, can access user profile information and volunteer opportunities, and may determine which volunteer opportunities to recommend to the user based on various factors, including for example, the user's volunteer interests, geography and field of working expertise. In some example embodiments, these opportunities can be conveniently presented to the user in a manner that is more accessible, thereby allowing the user to more easily sign up and participate in volunteer organizations that better suit his or her skills and interests.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

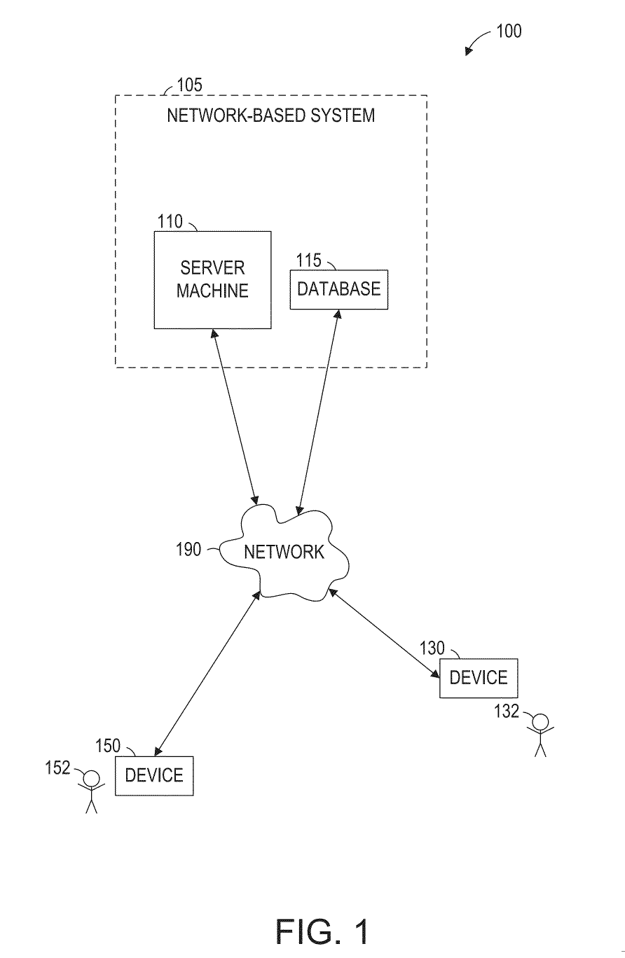

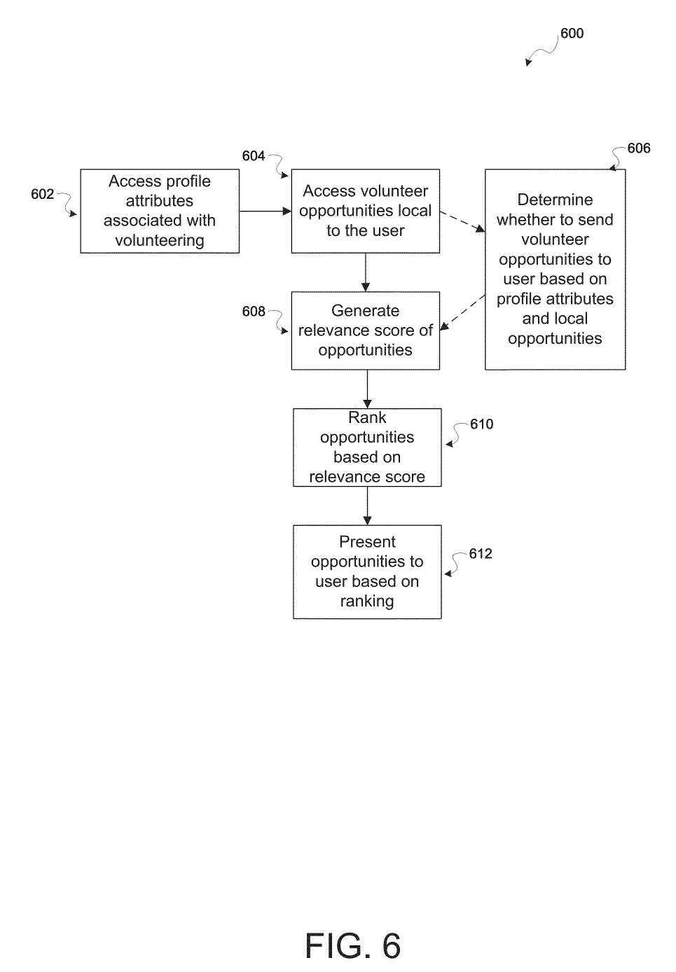

Referring to FIG. 1, an example network diagram illustrating a network environment 100 suitable for recommending volunteer opportunities to professionals through social network services is shown, according to some example embodiments. The network environment 100 includes a server machine 110, a database 115, a first device 130 for a first user 132, and a second device 150 for a second user 152, all communicatively coupled to each other via a network 190. The server machine 110 may form all or part of a network-based system 105 (e.g., a cloud-based server system configured to provide one or more services to the devices 130 and 150). The database 115 can store search features (e.g., profile data, social graph data) for the social network service. The server machine 110, the first device 130 and the second device 150 may each be implemented in a computer system, in whole or in part, as described below with respect to FIG. 6.

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 may be associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 may be associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 6. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

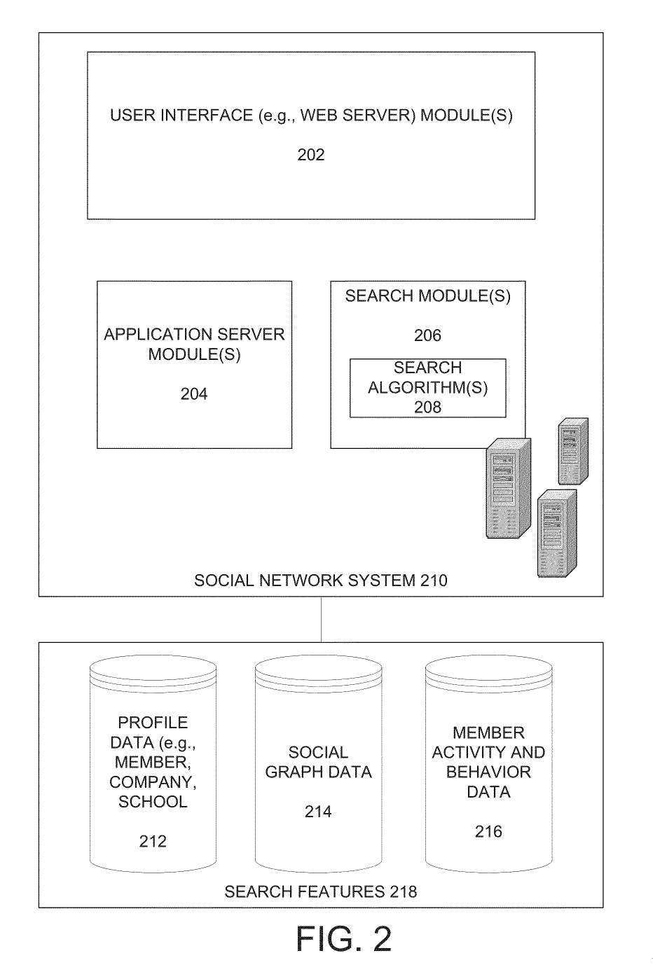

Referring to FIG. 2, a block diagram illustrating components of a social network system 210 is shown, according to some example embodiments. The social network system 210 may be an example of a network-based system 105 of FIG. 1 and may be suitable for recommending volunteer opportunities to professionals in the social network system 210. The social network system 210 can include user interface module(s) 202, application server module(s) 204, and search module(s) 206, which may all be configured to communicate with each other (e.g., via a bus, shared memory, a switch). The search module(s) 206 can further include a database with search algorithms 208. Furthermore, the social network system 210 can communicate with database 115 of FIG. 1, such as a database storing search features 218. The search features 218 can include profile data 212, social graph data 214, and member activity and behavior data 216.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In FIG. 2, in some example embodiments, the front end can include a user interface module (e.g., a web server) 202, which can receive requests (e.g., search requests) via network 190 from various client-computing devices (e.g., devices 130 and 150), and can communicate appropriate responses to the requesting client devices. For example, the user interface module(s) 202 may receive search requests (e.g., name search requests) in the form of Hypertext Transport Protocol (HTTP) requests, or other web-based, application programming interface (API) requests. The application logic layer can include various application server module(s) 204, which, in conjunction with the user interface module(s) 202, can generate various user interfaces (e.g., web pages) with data retrieved (e.g., search results) from various data sources in the data layer. With some embodiments, individual application server modules 204 are used to implement the functionality associated with various services and features of the social network system 210.

The search module(s) 206 in conjunction with the user interface module(s) 202 and the application server module(s) 204 can present search results based on search algorithm(s) 208. The search algorithm(s) 208 can perform functions for recommending volunteer opportunities to users of the social network system 210, according to some example embodiments. The search algorithm(s) 208 can utilize the various data included in the search features 218, including profile data 212, social graph data 214, and member activity and behavior data 216. Search algorithm(s) 208 can include machine learning techniques. For example, a searcher can request a name search. The search module(s) 206 can use the search algorithm(s) 208 to present names of users in the social network system 210 that may be relevant to the searcher based on search features 218 that are specific to the searcher.

Still referring to FIG. 2, the data layer can include several databases, such as a database for search features 218 for storing profile data 212, including both member profile data as well as profile data for various organizations. Additionally, the database for search features 218 can store social graph data 214 and member activity and behavior data 216.

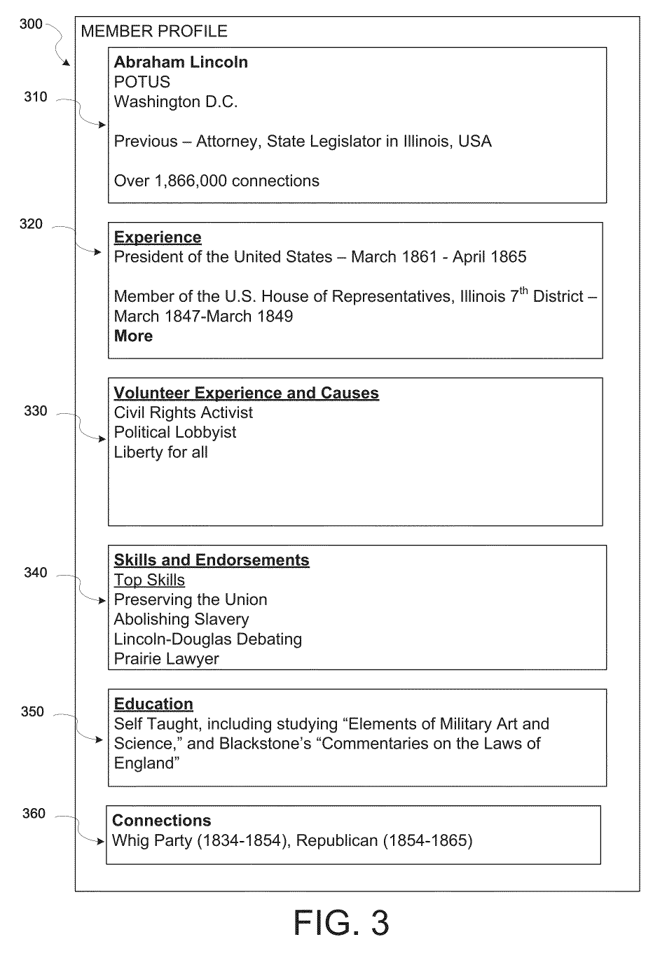

Referring to FIG. 3, example member profile 300 is shown of a user or member of a social network who may receive recommendations about volunteer opportunities, consistent with aspects of the present disclosure. An example of the user can include user 132 or 152. The member profile 300 can include information from the profile data 212, social graph data 214, and/or member activity and behavior data 216. The user, such as user 132, may access the member profile 300 through various user interfaces, such as user interface module(s) 202. The member profile 300 may be stored in memory in a networked server, such as database 115 residing in the network-based system 105.

Various information can be available in the member profile 300 that may be useful for recommending volunteer opportunities to the user 132. For example, introductory information in window 310 can supply the user 132's name, geographic location, current occupation, and previous experience. In addition, information in the experience window 320 can provide more detail regarding the user 132's current and previous work experience, including a more complete history, description, and dates of service.

As another example, window 330 can contain a list of volunteer experience and causes that the user 132 may be currently interested in or has participated in previously. Window 330 can include titles of positions in volunteer organizations the user 132 has held, the names of the volunteer organizations themselves, and descriptions of types of causes or volunteer areas that the user 132 is currently interested in.

As another example, window 340 can include a description of skills and endorsements that the user 132 possesses. In this example, a listing of “top skills” is shown, but other information can be included, including a listing of generic skills, any certifications to demonstrate skill or expertise in a particular field, names of other users who have endorsed the user 132 for a particular skill, and a listing of categories that the user 132 has been endorsed for. In some cases, designations like endorsements and the names of people endorsing the user 132 may be provided only through the promotion from other users interacting with the user 132's profile.

As yet another example, window 350 can include a listing of education of the user 132. In this example, the user 132 has a listing describing the user 132 as being self-taught, with a description of certain books the user 132 has studied. In other cases, additional educational experience, such as names of schools and universities, types of degrees, area of study within those degrees, test scores, and educational certifications can also be listed. The user 132 may also include a description or listing of classes taken, and any grades or honors worth noting.

As yet another example, window 360 can include a listing or description of connections of people and organizations that the user 132 is associated with. In this example, the user 132 has included a description of two political parties he has been a member of. In other cases, additional descriptions, such as listings of particular individuals, names of associations, religious organizations, and club memberships can be included in window 360.

In some example embodiments, any or all of this information in example member profile 300 can be used to help connect the user 132 to volunteer opportunities. Examples of how aspects of the present disclosure may utilize this information will be described in more detail below. In some example embodiments, the information contained in the member profile 300 can be entered manually by the user 132, for example, by typing in the information into text fields available in the member profile 300 and associated with each of the windows 310-360. Alternatively, the information in the member profile 300 can be selected from drop-down menus or other preselected text fields, and embodiments are not so limited. In some example embodiments, the types of information described in FIG. 3 can be included in the member profile 300 in different ways, such as in different text fields or organized in a different manner apparent to those of ordinary skill in the art, and embodiments are not so limited.

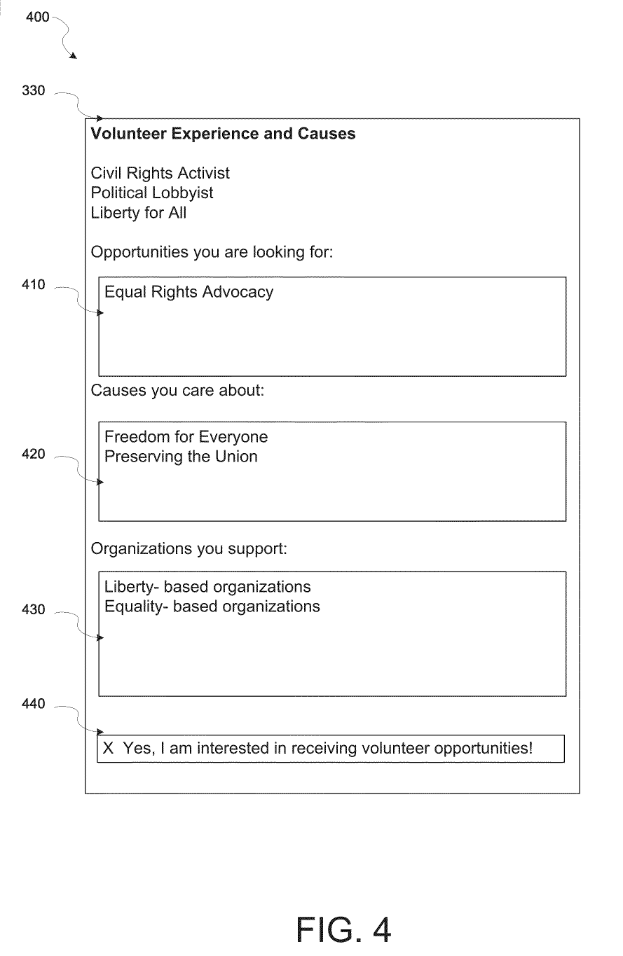

Referring to FIG. 4, illustration 400 shows additional information and selections that can be entered by the user 132 to signal his intent to find suitable volunteer opportunities, according to some example embodiments. Here, the user 132 can enter additional information in the window 330 to provide additional details for what types of volunteer opportunities he may be interested in. For example, in window 410, the user 132 can enter a listing or description of types of volunteer opportunities user 132 is looking for. Here for example, the phrase, “equal rights advocacy” has been entered into window 410 as a general type of area that the user 132 is interested in volunteering in.

In addition, additional information can be entered into window 420, regarding types of causes that the user 132 cares about. In some example embodiments, the description of the causes can be manually entered by the user 132, and in other cases the user 132 may have the ability to select, from a drop-down menu or other pre-existing listing, any number of descriptions of causes that he may care about. Here for example, the user 132 has either manually entered or selected from some pre-existing listing the causes of “freedom for everyone,” and “preserving the Union.”

Furthermore, additional information can be entered into window 430, regarding current organizations supported by the user 132. In some cases, the organizations can be specifically named, while in other cases the organizations can be broadly described, based on, for example, a theme or a type of cause that the organizations are working towards. Here for example, the user 132 has either manually entered or selected from some pre-existing listing the descriptions of “liberty-based organizations,” and “equality-based organizations.” Again, other examples may include specific names of organizations, such as the Red Cross, the American Civil Liberties Union, and the like.

In some example embodiments, volunteer recommendations can be provided to the user 132 only after the user 132 has indicated a desire to receive said recommendations. As such, the user 132 may check a box or confirm the desire to receive volunteer opportunities, as shown in the example checkbox 440.

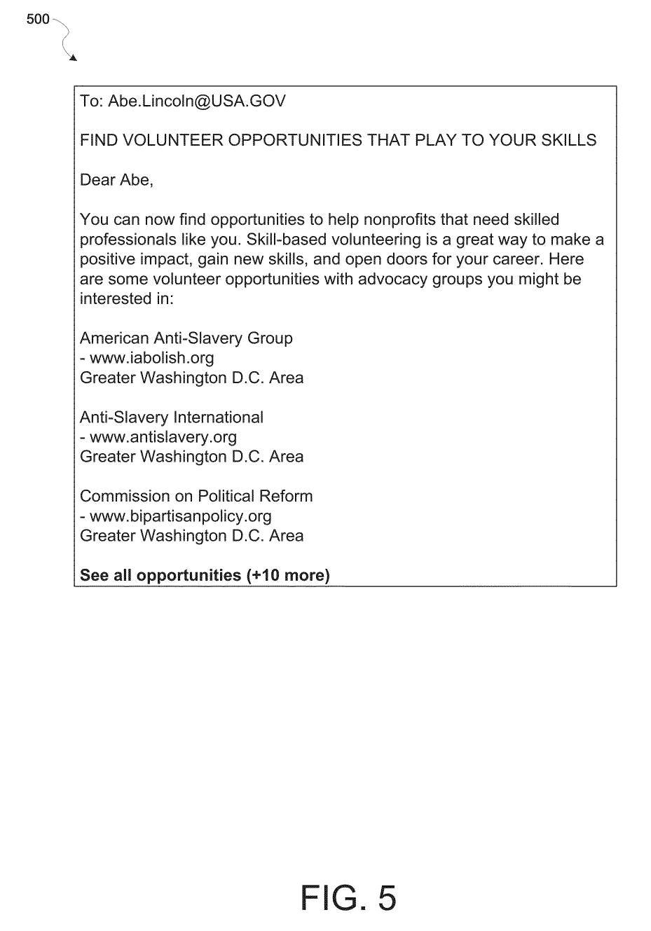

Referring to FIG. 5, in some example embodiments, the user 132 may receive communications, such as example email 500 regarding recommendations for volunteer opportunities based on information provided by the user 132 in his member profile 300. As shown, the example email 500 can communicate to the user 132 multiple suggestions for volunteer groups or nonprofit organizations that the user 132 can take a part of, and that are based in a geographic area local to where the user 132 lives. The multiple suggestions for volunteer groups may also be based on other factors, including factors incorporated into a relevance scoring and ranking of the multiple suggestions, described more below. In addition, links to websites associated with the volunteer groups can be provided. In some cases, brief descriptions of the organizations can also be listed. The example email 500 can also contain links (not shown) to interfaces to sign up for specific volunteer activities associated with one or more of the volunteer groups.

The information associated with each of the volunteer groups could be provided by each of the volunteer groups to the network-based system 105 that is configured to provide the recommendations to the user 132 based on his member profile information, social connections web activity. Each of the volunteer groups or nonprofit organizations can submit descriptions about their organizations, including what professional needs they may have, what types of causes they focus on, e.g., human rights, animal rights, community service, racial equality, etc., what geographic areas they service, contact information, in any specific application information that may be needed to process a potential volunteer. In some example embodiments, the volunteer groups can also provide secondary information, such as related volunteer group affiliates, a description of their mission statement, listings of staff members and board members, and a list of volunteers already associated with the volunteer group.

In some example embodiments, the information about the volunteer group can be researched and gathered by the network-based system 105 or researchers associated with the network-based system 105. In other words, the volunteer group may not provide the information itself, but the information can be researched online.

Referring to FIG. 6, the flowchart illustrates an example methodology 600 for providing recommendations for volunteer opportunities to users of the social network, such as working professionals, according to aspects of the present disclosure. The example methodology 600 may be consistent with the methods described herein, including, for example, the descriptions in FIGS. 3, 4, and 5, and may be directed from the perspective of a program or device configured to recommend volunteer opportunities to the user 132, such as the network-based system 105 or devices 130 or 150.

At block 602, an application or program according to some embodiments may access member profile attributes. Examples of member profile attributes can include the information described in the member profile 300. For example, the user 132's work experience, volunteer experience, skills and endorsements, education, and connections can all be relevant attributes associated with volunteer opportunities. Additionally, select behavior on the web, including what nonprofit organizations and nonprofit professionals they engage with, can provide further information associated with the individual's volunteering preferences.

At block 604, the application or program can access volunteer opportunities that may be local to the user 132 based on the user 132's stated geographic location. The volunteer opportunities can be accessed from a database or other type of memory storing information about the volunteer opportunities, such as database 115. In some example embodiments, at block 606, the application or program can determine whether to send volunteer opportunities to the user 132 based on the accessed profile attributes and the volunteer opportunities that are local to the user 132. For example, the user 132 may not have specified in his member profile 300 that he is interested in receiving any volunteer opportunity communications, and therefore the volunteer opportunities may not be sent to the user 132. In other cases, while the user 132 may have specified to receive volunteer opportunities, there may be an insufficient number of opportunities available in the user 132's geographic location, such that volunteer opportunities may not be sent to the user 132. As another example, even if the user 132 did not indicate a desire in checkbox 440 to receive volunteer opportunities, based on the user 132 having enough volunteer experience to satisfy some threshold criterion, e.g., as expressed in window 330, it may be determined to present additional volunteer opportunities to the user 132. For example, if the user 132 is listed over five years of volunteer experience, or has listed over seven different types of volunteer experience, the threshold criteria for determining to send volunteer opportunities may be satisfied.

At block 608, in some example embodiments, the application or program may generate a relevance score for one or more volunteer opportunities that may be within the relevant geographic vicinity of the user 132. The relevance score can be based on any number of factors from the accessed member profile attributes (from block 602) and information associated with the accessed volunteer opportunities (from block 604). For example, a weight or score may be given to each of the user 132's amount of work experience, volunteer experience and listed causes, listed skills, endorsements, education, and connections. For example, a higher score for any of these attributes may indicate a higher relevance to matching various volunteer opportunities. As another example, a plurality of scores can be applied to each of these example attributes, where each of the scores within the plurality of scores is associated with different types or categories of volunteer opportunities. For example, work experience as a veterinarian may be more relevant to doing volunteer work related to animals, while it may be less relevant to doing volunteer work related to criminal justice advocacy. As another example, having top skills in writing and debating may be more relevant to doing volunteer work in nonprofit grant proposal writing, while it may be less relevant to volunteering at a day care center. As another example, heavy weights can be applied to the stated volunteer causes described in windows 330 and 420. Therefore, multiple scores or weights can be applied to each attribute in the member profile based on relevance to different types of volunteer opportunities. In some example embodiments, the application or program can apply machine learning techniques to interpret the meaning of some descriptions that are manually entered by the user 132, after which a score or weight can be applied. In other cases, the scores or weights could be predetermined with member profile information based on drop-down menus.

An example algorithm for generating a relevance score according to some example embodiments is as follows:

For each member-volunteer opportunity pair, a score is generated. This absolute score could be a weighted sum of the following components:
a. Network connectedness between member and nonprofit organization, based on employment experiences and volunteer experience of the individual's connections to a given nonprofit
b. Propensity for other professionals similar to the individual to work or volunteer at the nonprofit, based on educational institution, educational degree, job function, current and past companies
c. Alignment of nonprofit's mission, based on its industry and the industries of its employees, to the causes the individual indicates s/he supports
d. Alignment of the volunteer role function to the individual's job function
e. Alignment of the nonprofit industry to the individual's current industry
f. Interest of individual in nonprofit signaled by the individual viewing the nonprofit's company page, jobs posted by the nonprofit, or profile pages of employees or volunteers of the nonprofit; the individual following that nonprofit company page
g. Interest of individual in similar nonprofits (e.g., those in the same industry, region) signaled by the individual viewing the nonprofit's company page, jobs posted by the nonprofit, or profile pages of employees or volunteers of the nonprofit; the individual having current or past volunteer or employment experience at similar nonprofits; the individual following those nonprofit company pages
h. Interest of current employees of nonprofit in the individual, signaled by employees or volunteers at the nonprofit viewing the member's profile
i. Interest of the individual in issues related to the nonprofit, signaled by the individual's consumption of relevant content to the nonprofit, and/or membership in online groups and forums related to the nonprofit's mission and cause
j. The interest expressed in the volunteer opportunity by professionals at large, signaled by the volume of applications, such that recommendations can be made to an individual about relevant opportunities that are receiving fewer applications (‘hidden gems’), increasing the likelihood that a given individual will be selected for the position

In some example embodiments, additional weights or scores can be applied to certain volunteer types or categories based on the type of profession or occupation the user 132 has, as well as what types of volunteer opportunities members connected to the user 132 are doing. For example, it may be reasoned that the user 132 may be more likely to want to volunteer at organizations where his colleagues or associates are volunteering, or where other members in his profession are volunteering. In some cases, it can also be expressed, e.g., in email 500, what volunteer opportunities his colleagues are participating in, as a way of incentivizing the user 132 to participate in the same volunteer opportunities.

In some example embodiments, greater weights or scores can be attached to particular volunteer organizations based on the timing of known volunteer opportunities. For example, if a particular organization publicizes that there is a large need for volunteers in the month of August, then as August approaches, greater weight to that particular organization may be given. As August passes, the weights to that particular organization may be reduced. Similarly, greater weight can be placed for an expressed need at a particular time for a particular type of skill or activity, such as legal writing, graphic artistry, violin playing, campaign canvassing, and packaging. For example, a political campaign can express a need for telephone campaigners during the month of October, and so volunteer opportunities for that particular organization, for that particular skill, can be given greater weight.

In some example embodiments, the scored or weighted profile attributes can be matched with the scored or weighted volunteer opportunities that are local to the user 132. This may generate a final score for each of the volunteer opportunities available to the user 132 that is particular to the user 132. In other words, each of these volunteer opportunities may have a different relevance score to a different user, such as user 152, based on her profile attributes in combination with the available volunteer opportunities.

At block 610, the volunteer opportunities may then be ranked based on the relevance score. As an example, volunteer opportunities that have a higher relevance score may be considered more relevant to the user 132, and therefore may be ranked higher. At block 612, the highest ranked opportunities may be presented to the user 132, such as via email 500 or on the web. In some cases, only the top few volunteer opportunities may be presented to the user 132, so as to not overwhelm the user 132. In other cases, lower ranking opportunities can also be presented as desired, for example in instances where an opportunity is relevant but has received fewer applications, making the member more likely to succeed in being selected for the position.

In some example embodiments, the ranking of the relevance scores may also be based on an optimization of the scores toward a particular goal or outcome. For example, the ranking may be based on a likelihood that the individual would be interested in the presented opportunity (e.g., a successful outcome is defined as: individual clicks on/applies to position). As another example, the ranking may be based on optimizing for a successful match between the individual and nonprofit (e.g., a successful outcome is defined as: the member applies to the opportunity and is selected for the position).

In some example embodiments, the relevance scoring and ranking process is based further on two-way matching between both the user and the volunteer/nonprofit organization, while in other cases one-way matching is performed. An example of two-way matching can include incorporating the relevance factors and ranking that lead to sharing relevant volunteer opportunities that are receiving fewer applications, in addition to those ranking opportunities based on relevant skills. In contrast, with one-way matching, the total number of applicants for a volunteer opportunity may not be factor.

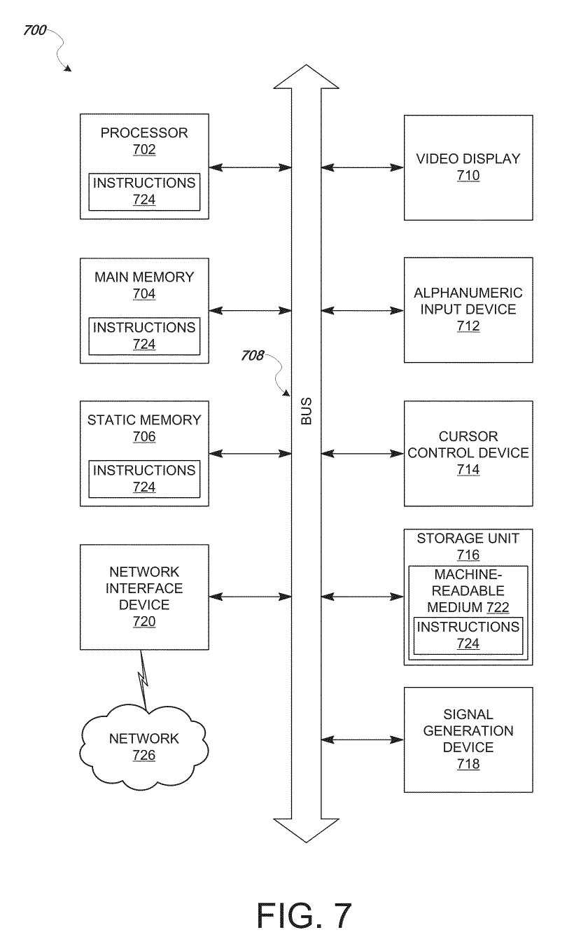

Referring to FIG. 7, the block diagram illustrates components of a machine 700, according to some example embodiments, able to read instructions 724 from a machine-readable medium 722 (e.g., a non-transitory machine-readable medium, a machine-readable storage medium, a computer-readable storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part.

In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a distributed (e.g., peer-to-peer) network environment. The machine 700 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine 700 is illustrated, the term “machine” shall also be taken to include any collection of machines that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a video display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or other pointing instrument), a storage unit 716, a signal generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein, including, for example, any of the descriptions of FIGS. 1-6. The instructions 724 may also reside, completely or at least partially, within the main memory 704, within the processor 702 (e.g., within the processor 702's cache memory), or both, before or during execution thereof by the machine 700. The instructions 724 may also reside in the static memory 706.

Accordingly, the main memory 704 and the processor 702 may be considered machine-readable media (e.g., tangible and non-transitory machine-readable media). The instructions 724 may be transmitted or received over a network 726 via the network interface device 720. For example, the network interface device 720 may communicate the instructions 724 using any one or more transfer protocols (e.g., Hypertext Transfer Protocol (HTTP)). The machine 700 may also represent example means for performing any of the functions described herein, including the processes described in FIGS. 1-6.

In some example embodiments, the machine 700 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions 724. The term “machine-readable medium” shall also be taken to include any medium, or combination of multiple media, that is capable of storing the instructions 724 for execution by the machine 700, such that the instructions 724, when executed by one or more processors of the machine 700 (e.g., processor 702), cause the machine 700 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium is non-transitory in that it does not embody a propagating signal. However, labeling the tangible machine-readable medium as “non-transitory” should not be construed to mean that the medium is incapable of movement; the medium should be considered as being transportable from one physical location to another. Additionally, since the machine-readable medium is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated descriptions define various example embodiments of methods, machine-readable media, and systems (e.g., apparatus) discussed herein:

1. A method comprising:

accessing, in a device, at least one member profile attribute of a user in an online network, the at least one member profile attribute associated with a plurality of volunteer opportunities;
accessing, in the device, information associated with the plurality of volunteer opportunities;
generating a relevance score for each of the plurality of volunteer opportunities, based on the at least one member profile attribute and the information associated with the plurality of volunteer opportunities;
ranking the plurality of volunteer opportunities based on the relevance scores; and
displaying at least some of the plurality of volunteer opportunities to the user based on the ranking.

2. The method of description 1, further comprising determining whether to display the plurality of volunteer opportunities based on the at least one member profile attribute and a number of local volunteer opportunities among the plurality of volunteer opportunities.

3. The method of description 1, wherein the at least one member profile attribute includes work experience information of the user and volunteer experience of the user.

4. The method of description 1, wherein the at least one member profile attribute includes skills information of the user and endorsements information of the user.

5. The method of description 1, wherein the at least one member profile attribute includes information about causes the user cares about and volunteer organizations the user supports.

6. The method of description 1, wherein generating the relevance score comprises computing a set of weights for each of a plurality of member profile attributes among the at least one member profile attribute, each weight of the set of weights for each of the plurality of member profile attributes based on a relevance comparison of the respective member profile attribute to each of the plurality of volunteer opportunities.

7. The method of description 6, wherein computing the set of weights for each of the plurality of member profile attributes is based further on a timing of a particular skill or occupation requested by one or more of the plurality of volunteer opportunities.

8. A system comprising an input interface, an output interface, and at least one processor configured to perform any of the descriptions in descriptions 1 through 7.

9. A computer-readable medium embodying instructions that, when executed by a processor, perform operations comprising any of the descriptions in descriptions 1 through 7.

10. An apparatus comprising means for performing any of the descriptions in descriptions 1 through 7.

What is claimed is:

1. A method comprising:
accessing, in a device, at least one member profile attribute of a user in an online social network, the at least one member profile attribute associated with a plurality of volunteer opportunities;
accessing, in the device, information associated with the plurality of volunteer opportunities;
generating a relevance score for each of the plurality of volunteer opportunities, based on the at least one member profile attribute and the information associated with the plurality of volunteer opportunities, each of the relevance scores indicating a predicted relevance of the corresponding volunteer opportunity to the user;
ranking the plurality of volunteer opportunities based on the relevance scores; and
displaying at least one of the plurality of volunteer opportunities to the user based on the ranking.

2. The method of claim 1, further comprising determining to display the plurality of volunteer opportunities based on the at least one member profile attribute and a number of local volunteer opportunities among the plurality of volunteer opportunities.

3. The method of claim 1, wherein the at least one member profile attribute includes work experience information of the user or volunteer experience of the user.

4. The method of claim 1, wherein the at least one member profile attribute includes skills information of the user or endorsements information of the user.

5. The method of claim 1, wherein the at least one member profile attribute includes a user-specified cause or a user-specific volunteer organization.

6. The method of claim 1, wherein generating the relevance score comprises computing a set of weights for each of a plurality of member profile attributes among the at least one member profile attribute, each weight of the set of weights for each of the plurality of member profile attributes based on a relevance comparison of the respective member profile attribute to each of the plurality of volunteer opportunities.

7. The method of claim 6, wherein computing the set of weights for each of the plurality of member profile attributes is based further on a timing of a request for a particular skill or occupation requested by one or more of the plurality of volunteer opportunities.

8. A system comprising:
a memory comprising at least one member profile attribute of a user in an online network, the at least one member profile attribute associated with a plurality of volunteer opportunities, and information associated with the plurality of volunteer opportunities;
a processor coupled to the memory and configured to:
access the at least one member profile attribute;
access the information associated with the plurality of volunteer opportunities;
generate a relevance score for each of the plurality of volunteer opportunities, based on the at least one member profile attribute and the information associated with the plurality of volunteer opportunities each of the relevance scores indicating a predicted relevance of the corresponding volunteer opportunity to the user; and
rank the plurality of volunteer opportunities based on the relevance scores; and
a user interface module coupled to the processor and configured to display at least one of the plurality of volunteer opportunities to the user based on the ranking.

9. The system of claim 8, wherein the processor is further configured to determine to display the plurality of volunteer opportunities based on the at least one member profile attribute and a number of local volunteer opportunities among the plurality of volunteer opportunities.

10. The system of claim 8, wherein the at least one member profile attribute includes work experience information of the user and volunteer experience of the user.

11. The system of claim 8, wherein the at least one member profile attribute includes skills information of the user and endorsements information of the user.

12. The system of claim 8, wherein the at least one member profile attribute includes a user-specified cause or a user-specific volunteer organization.

13. The system of claim 8, wherein generating the relevance score comprises computing a set of weights for each of a plurality of member profile attributes among the at least one member profile attribute, each weight of the set of weights for each of the plurality of member profile attributes based on a relevance comparison of the respective member profile attribute to each of the plurality of volunteer opportunities.

14. The system of claim 13, wherein computing the set of weights for each of the plurality of member profile attributes is based further on a timing of a particular skill or occupation requested by one or more of the plurality of volunteer opportunities.

15. A computer-readable medium embodying instructions that, when executed by a processor, perform operations comprising:
accessing at least one member profile attribute of a user in an online network, the at least one member profile attribute associated with a plurality of volunteer opportunities;
accessing information associated with the plurality of volunteer opportunities;
generating a relevance score for each of the plurality of volunteer opportunities, based on the at least one member profile attribute and the information associated with the plurality of volunteer opportunities, each of the relevance scores indicating a predicted relevance of the corresponding volunteer opportunity to the user;
ranking the plurality of volunteer opportunities based on the relevance scores; and
displaying at least one of the plurality of volunteer opportunities to the user based on the ranking.

16. The computer-readable medium of claim 15, wherein the operations further comprise determining to display the plurality of volunteer opportunities based on the at least one member profile attribute and a number of local volunteer opportunities among the plurality of volunteer opportunities.

17. The computer-readable medium of claim 15, wherein the at least one member profile attribute includes work experience information of the user or volunteer experience of the user.

18. The computer-readable medium of claim 15, wherein the at least one member profile attribute includes skills information of the user, endorsements information of the user, a user-specified cause or a user-specific volunteer organization.

19. The computer-readable medium of claim 15, wherein generating the relevance score comprises computing a set of weights for each of a plurality of member profile attributes among the at least one member profile attribute, each weight of the set of weights for each of the plurality of member profile attributes based on a relevance comparison of the respective member profile attribute to each of the plurality of volunteer opportunities.

20. The computer-readable medium of claim 19, wherein computing the set of weights for each of the plurality of member profile attributes is based further on a timing of a request of a particular skill or occupation requested by one or more of the plurality of volunteer opportunities.
